(19) United States
(12) Patent Application Publication
(10) Pub. No.: US 2026/0188591 A1
(43) Pub. Date: Jul. 2, 2026

(54) MULTILAYER ELECTRONIC COMPONENT

(71) Applicant: SAMSUNG ELECTRONICS CO., LTD., Suwon-si (KR)

(72) Inventor: Inyeol YUN, Suwon-si (KR)

(73) Assignee: SAMSUNG ELECTRONICS CO., LTD., Suwon-si (KR)

(21) Appl. No.: 19/301,292

(22) Filed: Aug. 15, 2025

(30) Foreign Application Priority Data
Dec. 31, 2024 (KR) 10-2024-0202408

(51) Int. Cl. H01G 4/30; H01G 4/012; H01G 4/232

(52) U.S. Cl. CPC H01G 4/30; H01G 4/012; H01G 4/232

(57) ABSTRACT

A multilayer electronic component includes a laminate in which first and second internal electrodes are alternately disposed in a lamination direction. A first group of external electrodes is disposed on at least one of a pair of opposing main surfaces of the laminate. These external electrodes are positioned adjacent to edges where side surfaces of the laminate meet and are electrically connected to the first internal electrodes. A second group of external electrodes is also disposed on at least one of the main surfaces, positioned between the first group in a lateral direction, and electrically connected to the second internal electrodes. Via-electrodes penetrate the laminate in the lamination direction to electrically connect the second internal electrodes to the second group of external electrodes. This structure enables multiple current paths and reduces current loop lengths, thereby lowering the equivalent series inductance and improving the high-frequency characteristics of the component.

### CROSS-REFERENCE TO RELATED APPLICATION(S)

This application claims the benefit of priority to Korean Patent Application No. 10-2024-0202408 filed on Dec. 31, 2024 with the Korean Intellectual Property Office, the disclosure of which is incorporated herein by reference in its entirety.

### BACKGROUND

The present inventive concept relates to a multilayer electronic component, and more specifically, to a multilayer ceramic capacitor (MLCC).

With the trend toward miniaturization and the implementation of higher degrees of capacitance in electronic devices, a multilayer ceramic capacitor (MLCC), an electronic component used in such devices, has also been required to have a reduced size and higher capacitance. An MLCC, an electronic component, may be mounted on the printed circuit boards of various types of electronic products such as image display devices, including a liquid crystal display (LCD) and a plasma display panel (PDP), computers, and smartphones, and may serve to charge or discharge electricity therein or therefrom. MLCCs may be used as components of various electronic devices due to having a small size and high capacitance. Recently, in addition to the miniaturization and high-capacitance trends of MLCCs, various studies have been conducted to enhance the reliability of MLCCs.

### SUMMARY

An aspect of the present inventive concept is to provide a multilayer electronic component with low equivalent series inductance (ESL).

According to an aspect of the present inventive concept, there is provided a multilayer electronic component including a laminate including first and second internal electrodes alternately disposed in a lamination direction, the laminate having a first main surface and a second main surface opposing each other in the lamination direction, and side surfaces facing a lateral direction, perpendicular to the lamination direction, the side surfaces connecting the first main surface and the second main surface to each other, a first group of external electrodes disposed on at least one of the first main surface and the second main surface, the first group of external electrodes adjacent to edges at which the side surfaces meet each other, the first group of external electrodes electrically connected to the first internal electrodes, a second group of external electrodes disposed on at least one of the first main surface and the second main surface, the second group of external electrodes positioned between the first group of external electrodes in the lateral direction, the second group of external electrodes electrically connected to the second internal electrodes, and via-electrodes passing through the laminate in the lamination direction, the via-electrodes connecting the second internal electrodes and the second group of external electrodes to each other. Each of the first internal electrodes may include lead-out portions connected to the first group of external electrodes, and a body portion connecting the lead-out portions to each other, the body portion spaced apart from the side surfaces of the laminate. A recess portion between the lead-out portions and between the side surfaces of the laminate and the body portion may be defined. The via-electrodes may pass through the recess portion and the second internal electrodes. A first separation distance between the side surfaces of the laminate and the body portion may be greater than a second separation distance between the side surfaces of the laminate and the second internal electrodes.

According to another aspect of the present inventive concept, there is provided a multilayer electronic component including a laminate including first and second internal electrodes alternately disposed in a lamination direction, the laminate having a pair of main surfaces opposing each other in the lamination direction, and side surfaces facing in a lateral direction, perpendicular to the lamination direction, the side surfaces connecting the pair of main surfaces to each other, a first group of external electrodes disposed on at least one surface, among the pair of main surfaces, the first group of external electrodes adjacent to edges at which the side surfaces meet each other, the first group of external electrodes electrically connected to the first internal electrodes, a second group of external electrodes disposed on at least one surface, among the pair of main surfaces, the second group of external electrodes positioned between the first group of external electrodes in the lateral direction, the second group of external electrodes electrically connected to the second internal electrodes, and via-electrodes passing through the laminate in the lamination direction, the via-electrodes connecting the second internal electrodes and the second group of external electrodes to each other.

According to another aspect of the present inventive concept, there is provided a multilayer electronic component including a laminate including first and second internal electrodes alternately disposed in a lamination direction, the laminate having a pair of main surfaces opposing each other in the lamination direction, and side surfaces facing in a lateral direction, perpendicular to the lamination direction, the side surfaces connecting the pair of main surfaces to each other, and a first group of external electrodes and a second group of external electrodes alternately disposed along a periphery of each of the pair of main surfaces. Each of the first internal electrodes may include lead-out portions connected to the first group of external electrodes, and a body portion connecting the lead-out portions to each other. The second internal electrodes may be connected to the second group of external electrodes, and may overlap the entire body portion and a portion of each of the lead-out portions in the lamination direction.

### BRIEF DESCRIPTION OF DRAWINGS

The above and other aspects, features, and advantages of the present inventive concept will be more clearly understood from the following detailed description, taken in conjunction with the accompanying drawings, in which:

FIG. 1 is a perspective view of a multilayer electronic component according to an example embodiment;

FIG. 2 is a cutaway perspective view of the multilayer electronic component shown in FIG. 1;

FIG. 3 is an exploded perspective view of a laminate of the multilayer electronic component shown in FIG. 1;

FIG. 4 is a plan view of a first internal electrode and a second internal electrode of the multilayer electronic component shown in FIG. 1;

FIG. 5 is a perspective view of a multilayer electronic component according to an example embodiment;

FIG. 6 is a cutaway perspective view of the multilayer electronic component shown in FIG. 5;

FIG. 7 is an exploded perspective view of a laminate of the multilayer electronic component shown in FIG. 5;

FIG. 8 is a plan view of a first internal electrode and a second internal electrode of the multilayer electronic component shown in FIG. 5;

FIG. 9 is a perspective view of a multilayer electronic component according to an example embodiment;

FIG. 10 is an exploded perspective view of a laminate of the multilayer electronic component shown in FIG. 9;

FIG. 11 is a plan view of a first internal electrode and a second internal electrode of the multilayer electronic component shown in FIG. 9;

FIG. 12 is a perspective view of a multilayer electronic component according to an example embodiment;

FIG. 13 is an exploded perspective view of a laminate of the multilayer electronic component shown in FIG. 12;

FIG. 14 is a perspective view of an electronic device on which a multilayer electronic component is mounted according to an example embodiment;

FIG. 15 is a cross-sectional view of an electronic device according to an example embodiment; and

FIG. 16 is a cross-sectional view of an electronic device according to an example embodiment.

### DETAILED DESCRIPTION

Hereinafter, preferred example embodiments will be described in detail. Unless otherwise described, the terms such as “upper,” “upper portion,” “upper surface,” “lower,” “lower portion,” “lower surface,” and “side surface” are based on the drawings, and may vary depending on a direction in which a component is actually arranged.

In addition, ordinal numbers such as “first,” “second,” “third,” and the like may be used as labels for specific elements, operations, directions, and the like, to distinguish various elements, steps, directions, and the like from one another. A term, not described in the specification using “first,” “second,” and the like, may still be referred to as “first” or “second” in the claims. In addition, a term referenced by a particular ordinal number (for example, “first” in a particular claim) may be described elsewhere with a different ordinal number (for example, “second” in the specification or another claim).

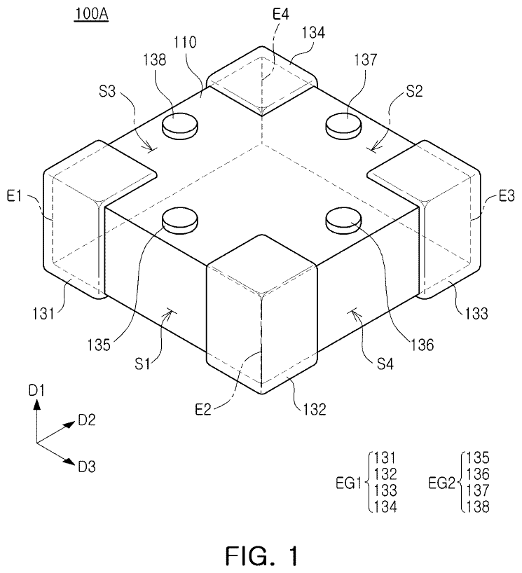

FIG. 1 is a perspective view of a multilayer electronic component 100A according to an example embodiment.

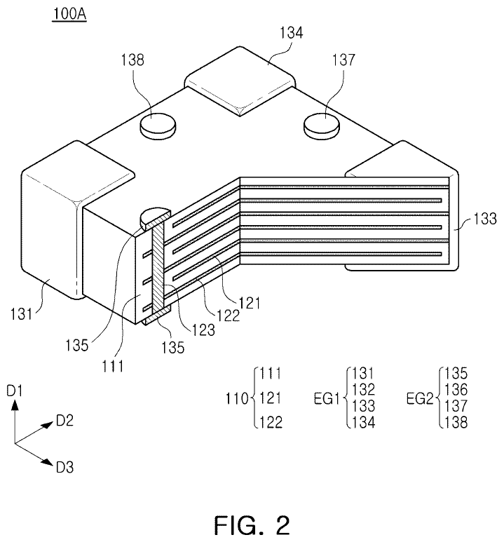

FIG. 2 is a cutaway perspective view of the multilayer electronic component 100A shown in FIG. 1.

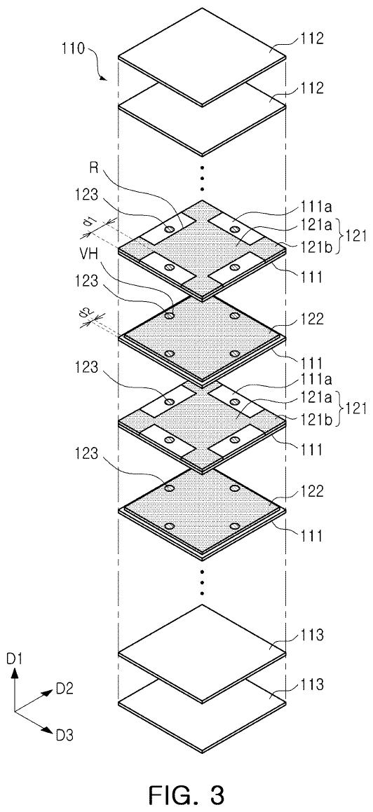

FIG. 3 is an exploded perspective view of a laminate 110 of the multilayer electronic component 100A shown in FIG. 1.

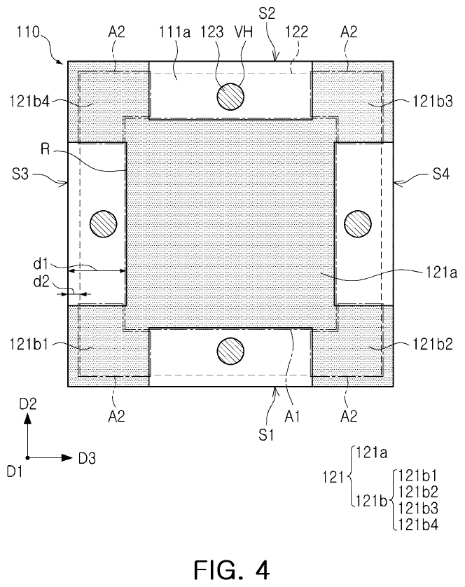

FIG. 4 is a plan view of a first internal electrode 121 and a second internal electrode 122 of the multilayer electronic component 100A shown in FIG. 1.

Referring to FIGS. 1 to 4, a multilayer electronic component 100A according to an example embodiment may include a laminate 110, a first group of external electrodes EG1, and a second group of external electrodes EG2. In the present specification, a multilayer ceramic capacitor (MLCC) is described as an example of the multilayer electronic component 100A. However, in some example embodiments, the multilayer electronic component may include various electronic products using a dielectric composition, for example, such as inductors, piezoelectric elements, varistors, thermistors, or the like.

According to example embodiments of the present inventive concept, the first group of external electrodes EG1 and the second group of external electrodes EG2, alternately disposed around a main surface of the laminate 110, may be applied, such that the number of current paths of the multilayer electronic component 100A may be increased, and a length or loop of each of the current paths may be decreased. As a result, a multilayer electronic component having low ESL may be implemented. In addition, an overlapping area between the internal electrodes 121 and 122 may be maximally secured, thereby implementing a multilayer electronic component having increased capacitance.

The laminate 110 may include a dielectric layer 111 and internal electrodes 121 and 122, alternately laminated. The laminate 110 may include first internal electrodes 121 and second internal electrodes 122, alternately laminated in a first direction D1 (a “lamination direction”), with a dielectric layer 111 interposed therebetween to form a capacitance determination portion.

A specific shape of the body 110 is not limited. However, the body 110 may have a hexahedral shape or a shape similar thereto. Due to the contraction of ceramic powder particles included in the laminate 110 during a sintering process, the laminate 110 may not have a hexahedral shape having perfectly straight lines, but may have a substantially hexahedral shape.

The laminate 110 may have a pair of main surfaces opposing each other in the lamination direction D1, and side surfaces S1, S2, S3, and S4. The side surfaces S1, S2, S3, and S4 of the laminate 110 may be facing in lateral directions D2 and D3, perpendicular to the lamination direction D1, and may connect a first main surface (for example, an upper surface in FIG. 1) and a second main surface (for example, a lower surface in FIG. 1). The laminate 110 may have a first side surface S1 and a second side surface S2 opposing each other in a first lateral direction D2, and a third side surface S3 and a fourth side surface S4 opposing each other in a second lateral direction D3, perpendicular to the first lateral direction D2.

The dielectric layer 111 may fill a space between the first internal electrodes 121 and the second internal electrodes 122, and may surround at least a portion of each of the first internal electrodes 121 and the second internal electrodes 122. The dielectric layer 111 may electrically isolate the first internal electrodes 121 and the second group of external electrodes EG2 from each other. The dielectric layer 111 may include an insulating portion 111a filling a space between the first internal electrodes 121 and via-electrodes 123. The insulating portion 111a may surround the via-electrodes 123 in a recess portion R of each of the first internal electrodes 121. The dielectric layer 111 may be in a sintered state, and adjacent dielectric layers 111 may be integrated with each other such that boundaries therebetween are not readily apparent without using a scanning electron microscope (SEM).

A raw material, included in the dielectric layer 111, is not limited as long as sufficient capacitance is obtainable therewith. For example, a barium titanate-based material, a lead composite perovskite-based material, or a strontium titanate-based material may be used for the raw material. The barium titanate-based material may include BaTiO₃-based ceramic powder particles, and examples of the ceramic powder particles may include BaTiO₃, and (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), or Ba(Ti_{1-y}Zr_{y})O₃ (0<y<1) obtained by partially dissolving Ca or Zr in BaTiO₃. The raw material, included in the dielectric layer 111, may be obtained by adding various ceramic additives, organic solvents, binders, dispersants, or the like to powder particles such as barium titanate (BaTiO₃) depending on the purpose of the example embodiments.

The dielectric layer 111 may have a thickness of about 3.0 μm or less, or about 1.0 μm or less in order to more easily achieve miniaturization and high capacitance of the multilayer electronic component. Here, the thickness of the dielectric layer 111 may refer to a thickness of the dielectric layer 111 disposed between the first internal electrode 121 and the second internal electrode 122 in the lamination direction D1. However, the thickness of the dielectric layer 111 is not limited to the above-described values. In addition, the thickness of the dielectric layer 111 may refer to an average thickness of the dielectric layer 111.

In addition, as illustrated in FIG. 3, a conductor layer 110 may include protective layers 112 and 113 disposed above and below the capacitance determination portion formed by the first internal electrodes 121 and the second internal electrodes 122. An upper protective layer 112 and a lower protective layer 113 may be formed by laminating a single dielectric layer or two or more dielectric layers on each of upper and lower surfaces of the capacitance determination portion in a vertical direction, and may basically serve to prevent damage to the internal electrodes 121 and 122 due to physical or chemical stress. The upper protective layer 112 and the lower protective layer 113 may not include an internal electrode, and may include a material the same as that of the dielectric layer 111.

The internal electrodes 121 and 122 may include first internal electrodes 121 and second internal electrodes 122, alternately laminated in the dielectric layer 111. The first internal electrode 121 and the second internal electrode 122 may be disposed to oppose each other with the dielectric layer 111, included in the laminate 110, interposed therebetween. The internal electrodes 121 and 122 may be electrically isolated from each other by the dielectric layer 111 interposed in the lamination direction D1. A material, included in the internal electrodes 121 and 122, is not limited, and a material having excellent electrical conductivity may be used. For example, the internal electrodes 121 and 122 may include at least one of nickel (Ni), copper (Cu), palladium (Pd), silver (Ag), gold (Au), platinum (Pt), tin (Sn), tungsten (W), titanium (Ti), and alloys thereof. In addition, the internal electrodes 121 and 122 may be formed by printing a conductive paste for an internal electrode, including the above-described materials, on a ceramic green sheet. The conductive paste for an internal electrode may be a screen-printing method, a gravure-printing method, or the like, but the present inventive concept is not limited thereto. The laminate 110 may be formed by alternately laminating ceramic green sheets on which the first and second internal electrodes 121 and 122 are printed, and then performing sintering thereon. The number of the laminated internal electrodes 121 and 122 may be greater than the number of those illustrated in the drawings. For example, the number of each of the laminated internal electrodes 121 and 122 may be 10 or 20 or less. The number of the internal electrodes 121 and 122 may be determined in consideration of ESL.

The first internal electrodes 121 may be electrically connected to a first group of external electrodes EG1. Each of the first internal electrodes 121 may include a body portion 121a and lead-out portions 121b. The body portion 121a may connect the lead-out portions 121b connected to the first group of external electrodes EG1 to each other, and may overlap the second internal electrodes 122 to form a capacitance determination portion. The body portion 121a may be spaced apart from side surfaces S1, S2, S3, and S4 of the laminate 110. Each of the first internal electrodes 121 may include a recess portion R. The body portion 121a and the lead-out portions 121b may define a recess portion R around the first internal electrodes 121. The recess portion R may be formed between the body portion 121a and the side surfaces S1, S2, S3, and S4 of the laminate 110. The lead-out portions 121b may extend from the body portion 121a to at least one side surface S1, S2, S3, or S4 of the laminate 110. The lead-out portions 121b may be connected to the first group of external electrodes EG1 on the at least one side surface S1, S2, S3, or S4 of the laminate 110.

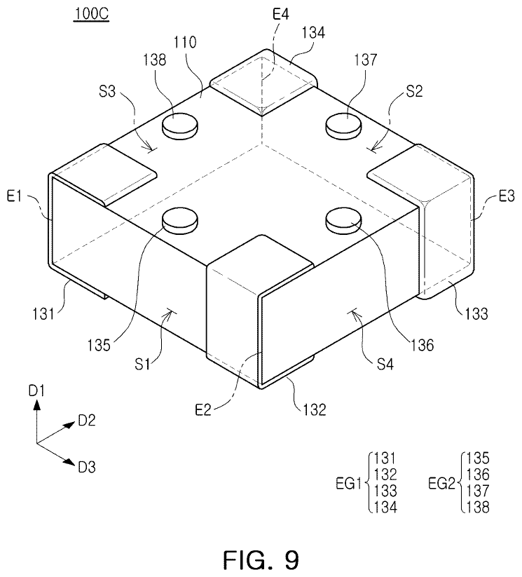

In an example embodiment, the first internal electrodes 121 may include first to fourth lead-out portions 121b1, 121b2, 121b3, and 121b4 extending toward edges E1, E2, E3, and E4 of the laminate 110 (see FIG. 4). The first lead-out portion 121b1 may extend to at least one surface, among the first and third side surfaces S1 and S3 adjacent to a first edge E1. The second lead-out portion 121b2 may extend to at least one surface, among the first and fourth side surfaces S1 and S4 adjacent to a second edge E2. The third lead-out portion 121b3 may extend to at least one surface, among the second and fourth side surfaces S2 and S4 adjacent to a third edge E3. The fourth lead-out portion 121b4 may extend to at least one surface, among the second and third side surfaces S2 and S3 adjacent to a fourth edge E4. In an example embodiment, the first lead-out portion 121b1 may be in contact with the first external electrode 131 on the first and third side surfaces S1 and S3. The second lead-out portion 121b2 may be in contact with the second external electrode 132 on the first and fourth side surfaces S1 and S4. The third lead-out portion 121b3 may be in contact with the third external electrode 133 on the second and fourth side surface S2 and S4. The fourth lead-out portion 121b4 may be in contact with the fourth external electrode 134 on the second and third side surfaces S2 and S3. In some example embodiments, the first to fourth lead-out portions 121b1, 121b2, 121b3, and 121b4 may each be in contact with the first group of external electrodes EG1 on a respective side surface of the laminate 110 (example embodiments in FIGS. 9 to 11).

The second internal electrodes 122 may be electrically connected to the second group of external electrodes EG2. The second internal electrodes 122 may be connected to the second group of external electrodes EG2 through the via-electrodes 123. The second internal electrodes 122 may include via-holes VH through which the via-electrodes 123 pass. The second internal electrodes 122 may overlap the first internal electrodes 121 in the lamination direction D1 to form a capacitance determination portion. The second internal electrodes 122 may have a shape capable of maximizing an overlapping region with the first internal electrodes 121 to improve capacitance per unit volume. The second internal electrodes 122 may overlap the entire body portion 121a of each of the first internal electrodes 121 and a portion of each of the lead-out portions 121b of the first internal electrodes 121.

As illustrated in FIG. 4, in plan view, an area of the second internal electrodes 122 overlapping the body portion 121a and the lead-out portions 121b may be about 55% or more of a planar area of the laminate 110. For example, in the laminate 110 having a size of 0.6 mm/0.6 mm (width/length), an overlapping area A1 between the second internal electrodes 122 and the entire body portion 121a may be about 152,802.81 μm², and an overlapping area A2 between the second internal electrodes 122 and a portion of each of the lead-out portions 121b may be about 55,444 μm² (about 58%). The second internal electrodes 122 may be formed to maximally secure the overlapping area A2 with the lead-out portions 121b. The overlapping area A2 between the second internal electrodes 122 and a portion of each of the lead-out portions 121b may be about 30% or more of the overlapping area A1 between the second internal electrodes 122 and the entire body portion 121a. A first separation distance d1 between the side surfaces S1, S2, S3, and S4 of the laminate 110 and the body portion 121a may be greater than a second separation distance d2 between the side surfaces S1, S2, S3, and S4 of the laminate 110 and the second internal electrodes 122. The second separation distance d2 may be about 50% or less of the first separation distance d1. For example, when the first separation distance d1 is about 100 μm, the second separation distance d2 may be about 50 μm or less. The second separation distance d2 may be determined in consideration of an overlapping area A1+A2 between the first internal electrode 121 and the second internal electrode 122 and electrical insulating properties of the second internal electrode 122.

The external electrodes EG1 and EG2 may include a first group EG1 and a second group EG2, alternately disposed a periphery of a main surface of the laminate 110. The external electrodes EG1 and EG2 may be arranged on the main surface and/or the side surfaces S1, S2, S3, and S4 of the laminate 110 to be spaced apart from each other. The external electrodes EG1 and EG2 may be formed of any material having electrical conductivity, such as a metal or the like, and a specific material may be determined in consideration of electrical properties, structural stability, and the like, and may further have a multilayer structure. For example, the external electrodes EG1 and EG2 may include an electrode layer on a surface of the laminate 110 and a plating layer on the electrode layer.

The electrode layer may be a sintered electrode including a conductive metal and glass, or a resin-based electrode including a conductive metal and a resin. In some example embodiments, the electrode layer may have a form in which the sintered electrode and the resin-based electrode are sequentially formed on the laminate 110. The conductive metal used for the electrode layer is not limited as long as it is a material capable of being electrically connected to the internal electrodes 121 and 122 to form capacitance. For example, the conductive metal may include at least one selected from the group consisting of nickel (Ni), copper (Cu), palladium (Pd), silver (Ag), gold (Au), platinum (Pt), tin (Sn), tungsten (W), titanium (Ti), and alloys thereof. The electrode layer may be formed by transferring a sheet including a conductive metal onto the laminate 110 or transferring the sheet including the conductive metal onto the sintered electrode. In some example embodiments, the electrode layer may be formed using an atomic layer deposition (ALD) method, a molecular layer deposition (MLD) method, a chemical vapor deposition (CVD) method, a sputtering method, or the like.

The plating layer may serve to improve mounting properties. A type of the plating layer is not limited, and may be a single plating layer including at least one of nickel (Ni), tin (Sn), palladium (Pd), and alloys thereof, or may be a plurality of layers including at least one of nickel (Ni), tin (Sn), palladium (Pd), and alloys thereof. For example, the plating layer may be a Ni plating layer or an Sn plating layer, may have a form in which a Ni plating layer and an Sn plating layer are sequentially formed on the electrode layer, or may have a form in which a Sn plating layer, a Ni plating layer, and an Sn plating layer are sequentially formed. In addition, the plating layer may include a plurality of Ni plating layers and/or a plurality of Sn plating layers.

The first group of external electrodes EG1 may be disposed on at least one surface, among the first main surface (for example, “upper surface” in FIG. 1) and the second main surface (for example, “lower surface” in FIG. 1) of the laminate 110. The first group of external electrodes EG1 may be adjacent to edges E1, E2, E3, and E4 at which the side surfaces S1, S2, S3, and S4 of the laminate 110 meet. The first group of external electrodes EG1 may be electrically connected to the first internal electrodes 121 on the main surface and/or the side surfaces S1, S2, S3, and S4 of the laminate 110. For example, the first group of external electrodes EG1 may include a first external electrode 131 adjacent to the first edge E1, a second external electrode 132 adjacent to the second edge E2, a third external electrode 133 adjacent to the third edge E3, and a fourth external electrode 134 adjacent to the fourth edge E4. The first external electrode 131 may be in contact with the first lead-out portion 121b1 on at least one surface, among the first side surface S1 and the third side surface S3. The second external electrode 132 may be in contact with the second lead-out portion 121b2 on at least one surface, among the first side surface S1 and the fourth side surface S4. The third external electrode 133 may be in contact with the third lead-out portion 121b3 on at least one surface, among the second side surface S2 and the fourth side surface S4. The fourth external electrode 134 may be in contact with the fourth lead-out portion 121b4 on at least one surface, among the second side surface S2 and the third side surface S3. The number of the first group of external electrodes EG1 may be greater than the number (four) of those illustrated in the drawings, depending on the shape of the laminate 110.

The second group of external electrodes EG2 may be disposed between the first group of external electrodes EG1 on at least one surface, among the first main surface (for example, “upper surface” in FIG. 1) and the second main surface (for example, “lower surface” in FIG. 1) of the laminate 110. The second group of external electrodes EG2 may be positioned between the first group of external electrodes EG1 in the lateral directions D2 and D3. The second group of external electrodes EG2 may be electrically connected to the second internal electrodes 122 on the main surface of the laminate 110. For example, the second group of external electrodes EG2 may include a fifth external electrode 135 positioned between the first external electrode 131 and the second external electrode 132 in the second lateral direction D3, a sixth external electrode 136 positioned between the second external electrode 132 and the third external electrode 133 in the first lateral direction D2, a seventh external electrode 137 positioned between the third external electrode 133 and the fourth external electrode 134 in the second lateral direction D3, and an eighth external electrode 138 positioned between the first external electrode 131 and the fourth external electrode 134 in the first lateral direction D2. The number of the second group of external electrodes EG2 may be greater than the number (four) of those illustrated in the drawings, depending on the shape of the laminate 110.

The second group of external electrodes EG2 may be connected to the second internal electrodes 122 through the via-electrodes 123 passing through the laminate 110. The via-electrodes 123 may be exposed to at least one main surface of the laminate 110 to be in contact with the second group of external electrodes EG2. The via-electrodes 123 may be connected to the second internal electrodes 122 in the laminate 110. The via-electrodes 123 may pass through the recess portions R of the first internal electrodes 121 and the via-holes VH of the second internal electrodes 122. The via-electrodes 123 may be in contact with the second internal electrodes 122 in the via-holes VH of the second internal electrodes 122. According to an example embodiment, the via-electrodes 123 may be disposed between the first group of external electrodes EG1 to reduce a current loop and a current path length and to reduce ESL.

The via-electrodes 123 may be electrically insulated from the first internal electrodes 121. The via-electrodes 123 may be insulated from the body portion 121a and the lead-out portions 121b by the insulating portion 111a, filling the recess portion R. The via-electrodes 123 may penetrate through the dielectric layer 111, the insulating portion 111a, and the second internal electrodes 122 in the lamination direction D1. The via-electrodes 123 may be formed using an appropriate process according to the thickness of the laminate 110. For example, the via-electrodes 123 may be formed by forming a via in the laminate 110 using a physical penetration method using a mechanical pin puncher or the like, or may be formed by filling the via with a conductive material. In this case, the conductive material may be one or more of nickel (Ni), copper (Cu), palladium (Pd), silver (Ag), gold (Au), platinum (Pt), tin (Sn), tungsten (W), titanium (Ti), and alloys thereof.

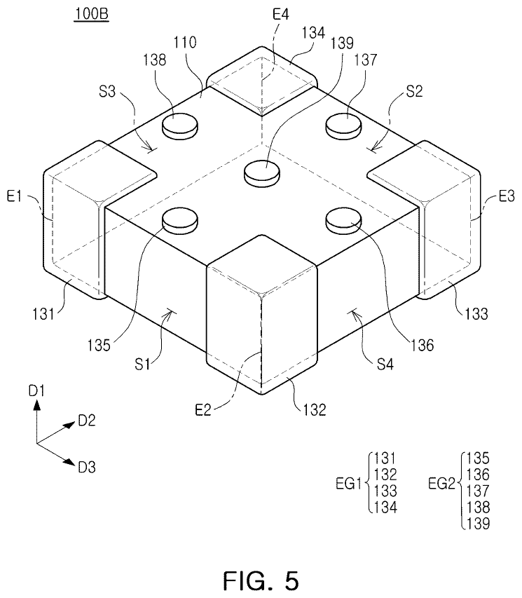

FIG. 5 is a perspective view of a multilayer electronic component 100B according to an example embodiment.

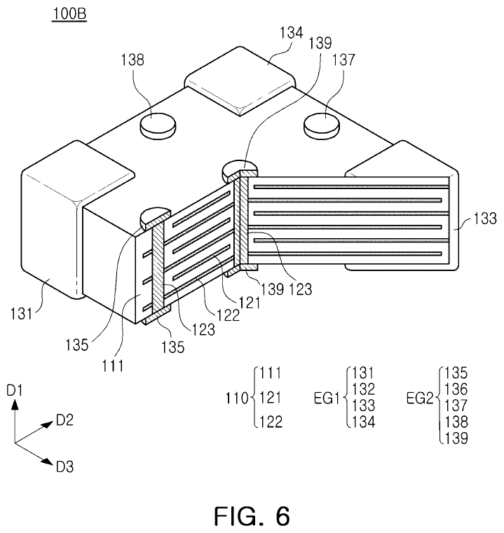

FIG. 6 is a cutaway perspective view of the multilayer electronic component 100B in FIG. 5.

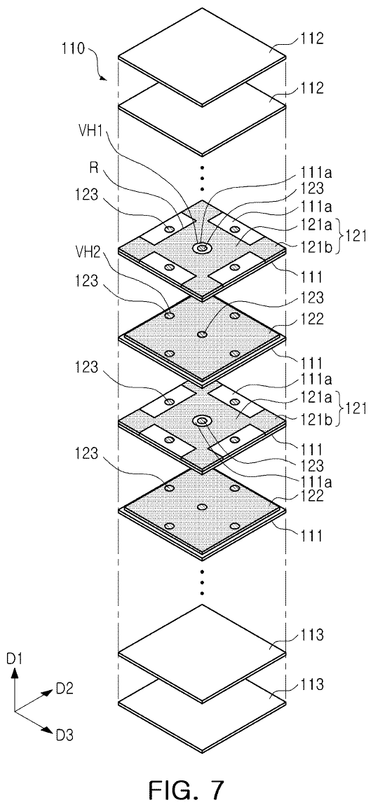

FIG. 7 is an exploded perspective view of a laminate 110 of the multilayer electronic component 100B in FIG. 5.

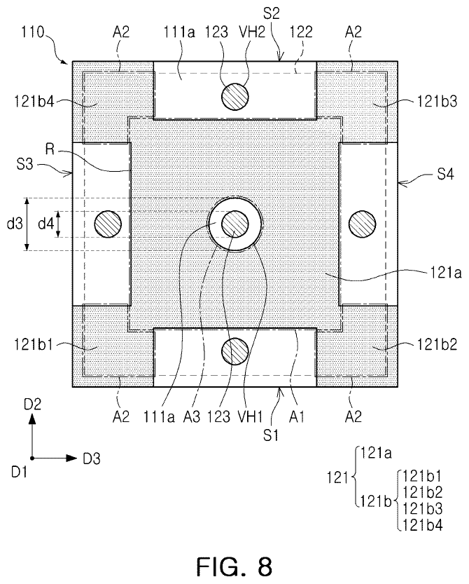

FIG. 8 is a plan view of a first internal electrode 121 and a second internal electrode 122 of the multilayer electronic component 100B in FIG. 5.

Referring to FIGS. 5 to 8, a multilayer electronic component 100B according to an example embodiment may have features the same as or similar to those described with reference to FIGS. 1 to 4, except that the multilayer electronic component 100B further includes a second group of external electrodes EG2 passing through a body portion 121a of a first internal electrode 121. The second group of external electrodes EG2 may further include a ninth external electrode 139 disposed at the center of a laminate 110. The ninth external electrode 139 may be positioned between a fifth external electrode 135 and a seventh external electrode 137 in a second side direction D3, and between a sixth external electrode 136 and an eighth external electrode 138 in a first side direction D2. The ninth external electrode 139 may reduce a current loop and a current path length, and may reduce ESL. The ninth external electrode 139 may be connected to second internal electrodes 122 through via-electrodes 123 passing through the laminate 110. The via-electrodes 123 may be exposed to at least one main surface of the laminate 110 to be in contact with the ninth external electrode 139. The via-electrodes 123 may be connected to the second internal electrodes 122 in the laminate 110. The via-electrodes 123 may pass through first via-holes VH1 of the first internal electrodes 121 and second via-holes VH2 of the second internal electrodes 122. The via-electrodes 123 may be insulated from the first internal electrodes 121 by an insulating portion 111a filling the first via-hole VH1. The via-electrodes 123 may be in contact with the second internal electrodes 122 in the second via-holes VH2 of the second internal electrodes 122.

As illustrated in FIG. 8, in plan view, an overlapping area A1+A2−A3 between the first internal electrodes 121 and the second internal electrodes 122 may be defined by an overlapping area A1 between the second internal electrodes 122 and the entire body portion 121a, an overlapping area A2 between the second internal electrodes 122 and a portion of each of the lead-out portions 121b, and an area A3 of the first via-hole VH1 passing through the body portion 121a. A diameter d3 of the first via-hole VH1 may be about twice a diameter d4 of the via-electrode 123, but the present inventive concept is not limited thereto. For example, the diameter d3 of the first via-hole VH1 may be about 100 μm, and the diameter d4 of the via-electrode 123 may be about 50 μm. The overlapping area A1+A2−A3 between the first internal electrodes 121 and the second internal electrodes 122 may be about 55% or more of a planar area of the laminate 110. For example, in the laminate 110 having a size of 0.6 mm/0.6 mm (width/length), the overlapping area A1 between the second internal electrodes 122 and the entire body portion 121a may be about 152,802.81 μm², the overlapping area A2 between the second internal electrodes 122 and a portion of each of the lead-out portions 121b may be about 55,444 μm², and the area A3 of the first via-hole VH1 may be about 7,853.98 μm² (about 56%). A separation distance between side surfaces S1, S2, S3, and S4 of the laminate 110 and the second internal electrodes 122 may be determined in consideration of the overlapping areas A1+A2−A3 between the first internal electrode 121 and the second internal electrode 122 and electrical insulating properties of the second internal electrode 122.

FIG. 9 is a perspective view of a multilayer electronic component 100C according to an example embodiment.

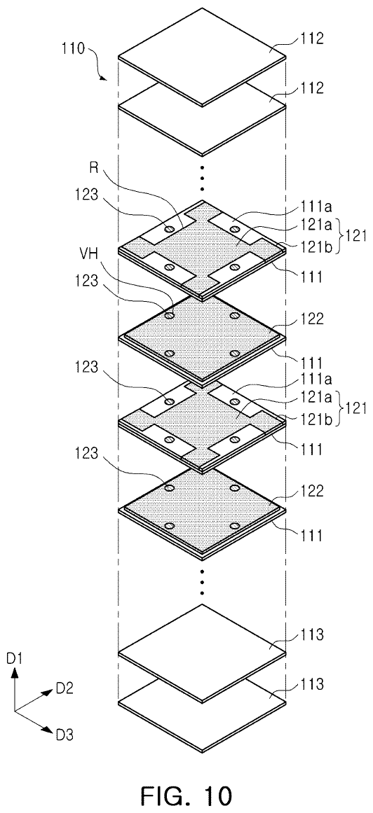

FIG. 10 is an exploded perspective view of a laminate 110 of the multilayer electronic component 100C in FIG. 9.

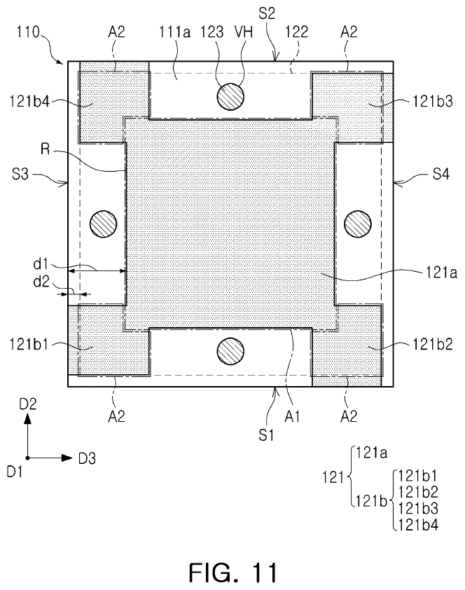

FIG. 11 is a plan view of a first internal electrode 121 and a second internal electrode 122 of the multilayer electronic component 100C in FIG. 9.

Referring to FIGS. 9 to 11, a multilayer electronic component 100C according to an example embodiment may have features the same as or similar to those described with reference to FIGS. 1 to 8, except that a first group of external electrodes EG1 are connected to first internal electrodes 121 only on one side surface S1, S2, S3, or S4 of a laminate 110.

The first group of external electrodes EG1 may be electrically connected to the first internal electrodes 121 on the one side surface S1, S2, S3, or S4 of the laminate 110. For example, a first external electrode 131 may be connected to the first internal electrode 121 on a third side surface S3, a second external electrode 132 may be connected to the first internal electrode 121 on a first side surface S1, a third external electrode 133 may be connected to the first internal electrode 121 on a fourth side surface S4, and a fourth external electrode 134 may be connected to the first internal electrode 121 on a second side surface S2. The number of the first group of external electrodes EG1 may be greater than the number (4) of those illustrated in the drawings, depending on a shape of the laminate 110.

The first internal electrodes 121 may include first to fourth lead-out portions 121b1, 121b2, 121b3, and 121b4 extending toward the one side surface S1, S2, S3, or S4 of the laminate 110 (see FIG. 11). The first lead-out portion 121b1 may extend toward the third side surface S3. The second lead-out portion 121b2 may extend toward the first side surface S1. The third lead-out portion 121b3 may extend toward the fourth side surface S4. The fourth lead-out portion 121b4 may extend toward the second side surface S2. In an example embodiment, the first lead-out portion 121b1 may be in contact with the first external electrode 131 on the third side surface S3. The second lead-out portion 121b2 may be in contact with the second external electrode 132 on the first side surface S1. The third lead-out portion 121b3 may be in contact with the third external electrode 133 on the fourth side surface S4. The fourth lead-out portion 121b4 may be in contact with the fourth external electrode 134 on the second side surface S2.

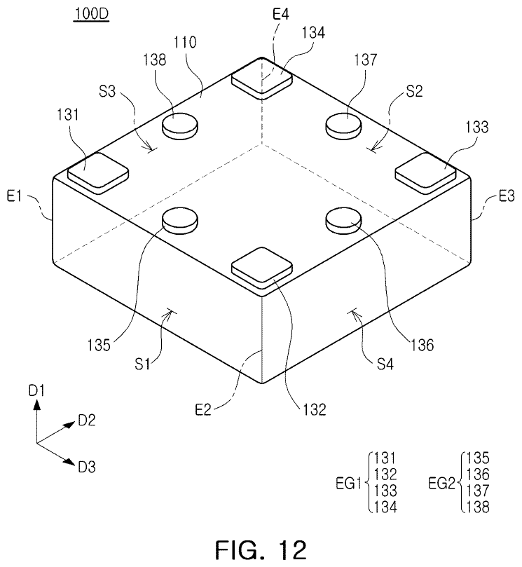

FIG. 12 is a perspective view of a multilayer electronic component 100D according to an example embodiment.

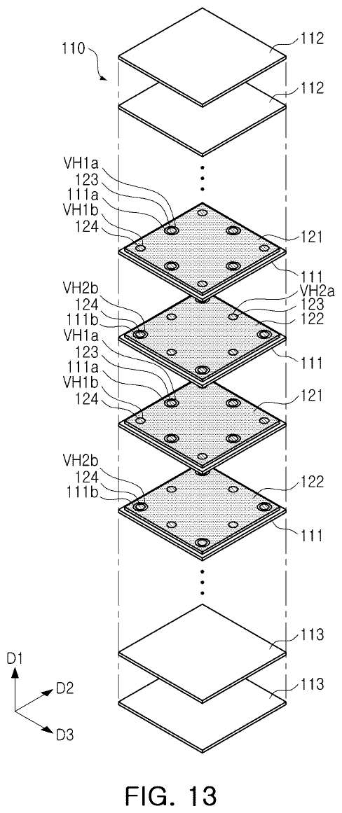

FIG. 13 is an exploded perspective view of a laminate of the multilayer electronic component 100D in FIG. 12.

Referring to FIGS. 12 and 13, a multilayer electronic component 100D according to an example embodiment may have features the same as or similar to those described with reference to FIGS. 1 to 11, except that the first group of external electrodes EG1 is disposed only on a first main surface (for example, “upper surface” in FIG. 1) and a second main surface (for example, “lower surface” in FIG. 1).

The first group of external electrodes EG1 may be adjacent to edges E1, E2, E3, and E4 of the laminate 110. The first group of external electrodes EG1 may be pad structures disposed on the main surfaces of the laminate 110. In the drawings, the first group of external electrodes EG1 are illustrated as having a rectangular shape unlike the second group of external electrodes EG2, but the shape is only for distinguishing from a shape of the second group. The first group EG1 may have a shape the same as that of the second group EG2. The first group of external electrodes EG1 may include a first external electrode 131 adjacent to the first edge E1, a second external electrode 132 adjacent to the second edge E2, a third external electrode 133 adjacent to the third edge E3, and a fourth external electrode 134 adjacent to the fourth edge E4. The number of the first group of external electrodes EG1 may be greater than the number (4) of those illustrated in the drawings, depending on a shape of the laminate 110.

The first group of external electrodes EG1 may be connected to first internal electrodes 121 through additional via-electrodes 124 penetrating through the laminate 110. The additional via-electrodes 124 may be exposed to at least one main surface of the laminate 110 to be in contact with the first group of external electrodes EG1. The additional via-electrodes 124 may be connected to the first internal electrodes 121 in the laminate 110. The additional via-electrodes 124 may pass through a first additional via-hole VH1b of each of the first internal electrodes 121 and a second additional via-hole VH2b of each of second internal electrodes 122. The additional via-electrodes 124 may be in contact with the first internal electrodes 121 in the first additional via-holes VH1b of the first internal electrodes 121. The additional via-electrodes 124 may be electrically insulated from the second internal electrodes 122. The additional via-electrodes 124 may be insulated from the second internal electrodes 122 by a second insulating portion 111b filling the second additional via-hole VH2b. The additional via-electrodes 124 may pass through a dielectric layer 111, the second insulating portion 111b, and the first internal electrodes 121 in a lamination direction D1.

The second group of external electrodes EG2 may be connected to the second internal electrodes 122 through via-electrodes 123 passing through the laminate 110. The via-electrodes 123 may pass through a first via-hole VH1a of each of the first internal electrodes 121 and a second via-hole VH2a of each of the second internal electrodes 122. The via-electrodes 123 may be in contact with the second internal electrodes 122 in the second via-holes VH2a of the second internal electrodes 122. The via-electrodes 123 may be electrically insulated from the first internal electrodes 121. The via-electrodes 123 may be insulated from the second internal electrodes 122 by a first insulating portion 111a filling the first via-hole VH1a. The via-electrodes 123 may pass through the dielectric layer 111, the first insulating portion 111a, and the second internal electrodes 122 in the lamination direction D1.

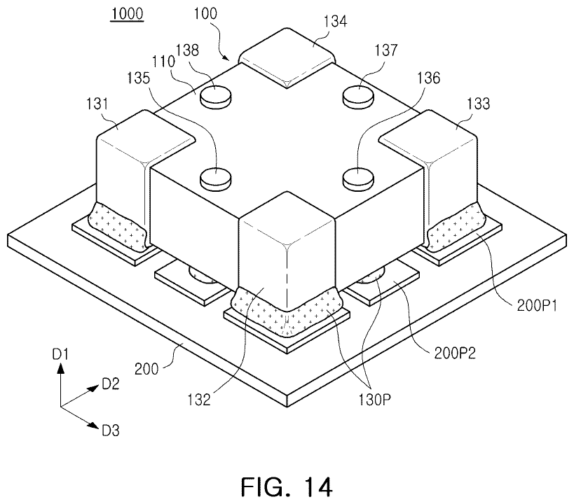

FIG. 14 is a perspective view of an electronic device 1000 on which a multilayer electronic component 100 is mounted according to an example embodiment.

Referring to FIG. 14, the electronic device 1000 according to an example embodiment may include a substrate 200 and a multilayer electronic component 100. The substrate 200 may be a substrate for a semiconductor package such as a printed circuit board (PCB), a silicon substrate, a ceramic substrate, a tape interconnection line board, or the like. The substrate 200 may include pads 200P1 and 200P2 on which the multilayer electronic component 100 is mounted. The pads 200P1 and 200P2 may include a first pad 200P1 and a second pad 200P2 supplying power to a first group of external electrodes EG1 and a second group of external electrodes EG2, respectively. The first pad 200P1 and the second pad 200P2 may have two or more different voltages. In this case, one of the different voltages may be a ground voltage.

The multilayer electronic component 100 may be used, for example, as a decoupling component for removing noise of an electrical signal in a set due to excellent high-frequency properties thereof (low ESL). The multilayer electronic component 100 may be connected to pads 200P1 and 200P2 of the substrate 200. The first group of external electrodes EG1 and the second group of external electrodes EG2 may be electrically connected to the first pad 200P1 and the second pad 200P2 through a solder 130P, respectively. The solder 130P may include tin (Sn), lead (Pb), silver (Ag), copper (Cu), gold (Au), or alloys thereof. The first group of external electrodes EG1 and the second group of external electrodes EG2 may have two or more different voltages. According to an example embodiment, the multilayer electronic component 100 may include the first group of external electrodes EG1 and the second group of external electrodes EG2, alternately disposed around a main surface of the laminate 110. Accordingly, the multilayer electronic component 100 may have low ESL properties in a high-frequency region. In addition, the multilayer electronic component 100 may maximally secure an overlapping area between the internal electrodes 121 and 122 as described with reference to FIG. 1, or the like, thereby securing high capacitance with excellent high-frequency properties.

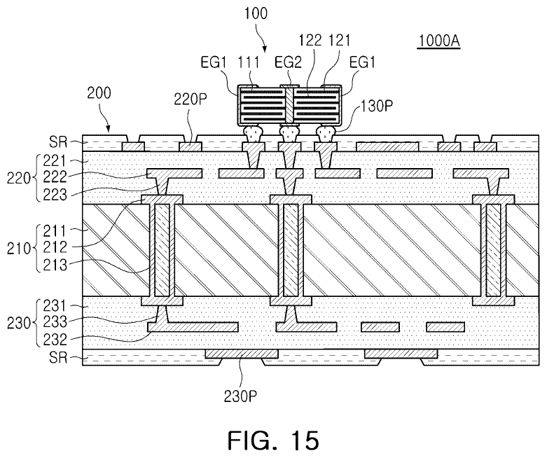

FIG. 15 is a cross-sectional view of an electronic device 1000A according to an example embodiment.

Referring to FIG. 15, the electronic device 1000A according to an example embodiment may include a substrate 200 and a multilayer electronic component 100. The multilayer electronic component 100 according to an example embodiment may be mounted on an upper surface and/or a lower surface of the substrate 200. The multilayer electronic component 100 may be connected to a pad 220P through a solder 130P.

The substrate 200 may include a core substrate portion 210, an upper substrate portion 220, and a lower substrate portion 230. In some example embodiments, the substrate 200 may include only a portion of the core substrate portion 210, the upper substrate portion 220, and the lower substrate portion 230. The substrate 200 is illustrated as a PCB as an example of a mounting substrate of the multilayer electronic components 100, but the present inventive concept is not limited thereto. For example, the substrate 200 may include a photosensitive resin-based organic substrate, a silicon-based interposer substrate, or the like.

The core substrate portion 210 may include a core insulating layer 211, core interconnection lines 212, disposed on both surfaces (upper and lower surfaces) of the core insulating layer 211, and a core via 213 passing through the core insulating layer 211 and connecting the core interconnection lines 212 to each other. The core substrate portion 210 may have a multilayered core substrate structure in which a plurality of core insulating layers 111 are laminated according to a design thereof. The core insulating layer 211 may improve rigidity of the substrate, thereby suppressing warpage of the substrate. In some example embodiments, a thickness of the core insulating layer 211 may be greater than a thickness of each of an upper build-up insulating layer 221 and a lower build-up insulating layer 231. The core insulating layer 211 may include an insulating material, for example, a thermosetting resin such as an epoxy resin, a thermoplastic resin such as polyimide, or a prepreg, an ABF, FR-4, or the like, including an inorganic filler or/and a glass fiber. The core insulating layer 211 may be formed using, for example, a copper clad laminate (CCL), an unclad CCL, a glass substrate, or a ceramic substrate. The core interconnection lines 212 and the core vias 213 may include a conductive material, for example, at least one metal or an alloy including two or more metals, among copper (Cu), aluminum (Al), nickel (Ni), silver (Ag), gold (Au), platinum (Pt), tin (Sn), lead (Pb), titanium (Ti), chromium (Cr), palladium (Pd), indium (In), zinc (Zn), and carbon (C). The core interconnection lines 212 may be electrically connected through the core via 213 passing through the core insulating layer 211. When the core via 213 is formed along an inner wall of a through-hole of the core insulating layer 211, an internal space of the through-hole may be filled with an insulating material such as an epoxy resin.

The upper substrate portion 220 may include an upper build-up insulating layer 221, an upper interconnection line 222, and an upper via 223. The upper build-up insulating layer 221 may include, for example, an insulating material such as a prepreg, an ABF, FR-4, or the like. The upper interconnection line 222 may be electrically connected to the core interconnection line 212 through the upper via 223. The upper interconnection line 222 may include pads 220P on which an external device is to be mounted.

The lower substrate portion 230 may include a lower build-up insulating layer 231, a lower interconnection line 232, and a lower via 233. The lower substrate portion 230 may have features similar to those of the upper substrate portion 220, and thus descriptions, overlapping those described above with respect to the lower build-up insulating layer 231, the lower interconnection line 232, and the lower via 233, will be omitted. The lower substrate portion 230 may have a symmetrical structure with respect to the core substrate portion 210. For example, both the lower via 233 and the upper via 223 may have a tapered shape having a decreasing width toward the core substrate portion 210. The lower interconnection line 232 may include pads 230P on which an external device is to be mounted.

A protective layer SR may be disposed on each of the upper substrate portion 220 and the lower substrate portion 230. The protective layer SR may have an opening, exposing at least a portion of each of the pad 220P of the upper interconnection line 222 and the pad 230P of the lower interconnection line 232. The protective layer SR may include, for example, a solder resist.

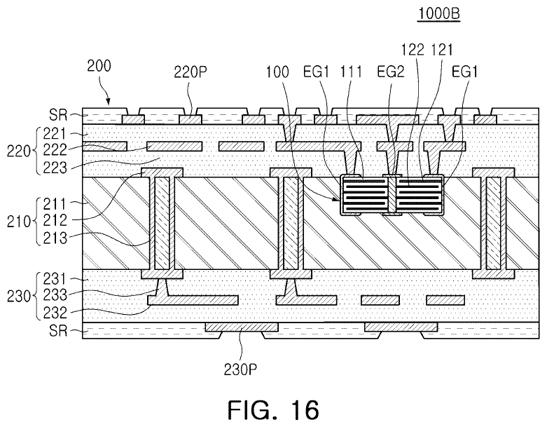

FIG. 16 is a cross-sectional view of an electronic device 1000B according to an example embodiment.

Referring to FIG. 16, an electronic device 1000B according to an example embodiment may include a multilayer electronic component 100 buried in a substrate 200. For example, the multilayer electronic component 100 may be disposed in a core substrate portion 210. The multilayer electronic component 100 may be electrically connected to an external device through an upper via 223 and an upper interconnection line 222. The multilayer electronic component 100 may receive external power through upper vias 223 connected to external electrodes EG1 and EG2. A first group of external electrodes EG1 and a second group of external electrodes EG2 may receive different voltages.

According to example embodiments of the present inventive concept, a current path may be increased and a length of the current path may be decreased, thereby providing a multilayer electronic component having low ESL.

While example embodiments have been shown and described above, it will be apparent to those skilled in the art that modifications and variations could be made without departing from the scope of the present inventive concept as defined by the appended claims.

What is claimed is:

1. A multilayer electronic component comprising:
a laminate including first and second internal electrodes alternately disposed in a lamination direction, the laminate having a first main surface and a second main surface opposite to the first main surface in the lamination direction, and side surfaces facing in a lateral direction, perpendicular to the lamination direction, the side surfaces connecting the first main surface and the second main surface to each other;
a first group of external electrodes disposed on at least one of the first main surface and the second main surface, the first group of external electrodes adjacent to edges at which the side surfaces meet each other, the first group of external electrodes electrically connected to the first internal electrodes;
a second group of external electrodes disposed on at least one of the first main surface and the second main surface and between the first group of external electrodes in the lateral direction, the second group of external electrodes electrically connected to the second internal electrodes; and
via-electrodes penetrating through the laminate in the lamination direction, the via-electrodes connecting the second internal electrodes and the second group of external electrodes to each other,
wherein each of the first internal electrodes includes:
lead-out portions connected to the first group of external electrodes;
a body portion connecting the lead-out portions to each other, the body portion spaced apart from the side surfaces of the laminate; and
a recess portion defined between the lead-out portions and between the side surfaces of the laminate and the body portion,
the via-electrodes pass through the recess portion and the second internal electrodes, and
a first separation distance between the side surfaces of the laminate and the body portion is greater than a second separation distance between the side surfaces of the laminate and the second internal electrodes.

2. The multilayer electronic component of claim 1, wherein the second separation distance is 50% or less of the first separation distance.

3. The multilayer electronic component of claim 1, wherein the second internal electrodes overlap the entire body portion and a portion of each of the lead-out portions in the lamination direction.

4. The multilayer electronic component of claim 3, wherein, in plan view, an area of the second internal electrodes, overlapping the body portion and the lead-out portions, is at least 55% of a planar area of the laminate.

5. The multilayer electronic component of claim 1, wherein
the side surfaces of the laminate include a first side surface and a second side surface opposite to each other in a first lateral direction, and a third side surface and a fourth side surface opposite to each other in a second lateral direction, perpendicular to the first lateral direction, and
the first group of external electrodes includes:
a first external electrode adjacent to a first edge between the first side surface and the third side surface;
a second external electrode adjacent to a second edge between the first side surface and the fourth side surface;
a third external electrode adjacent to a third edge between the second side surface and the fourth side surface; and
a fourth external electrode adjacent to a fourth edge between the second side surface and the third side surface.

6. The multilayer electronic component of claim 5, wherein the lead-out portions of the first internal electrodes include:
a first lead-out portion extending to at least one surface, among the first side surface and the third side surface;
a second lead-out portion extending to at least one surface, among the first side surface and the fourth side surface;
a third lead-out portion extending to at least one surface, among the second side surface and the fourth side surface; and
a fourth lead-out portion extending to at least one surface, among the second side surface and the third side surface.

7. The multilayer electronic component of claim 6, wherein
the first external electrode is in contact with the first lead-out portion on at least one surface, among the first side surface and the third side surface,
the second external electrode is in contact with the second lead-out portion on at least one surface, among the first side surface and the fourth side surface,
the third external electrode is in contact with the third lead-out portion on at least one surface, among the second side surface and the fourth side surface, and
the fourth external electrode is in contact with the fourth lead-out portion on at least one surface, among the second side surface and the third side surface.

8. The multilayer electronic component of claim 5, wherein the second group of external electrodes includes:
a fifth external electrode between the first external electrode and the second external electrode in the second lateral direction;
a sixth external electrode between the second external electrode and the third external electrode in the first lateral direction;
a seventh external electrode between the third external electrode and the fourth external electrode in the second lateral direction; and
an eighth external electrode between the first external electrode and the fourth external electrode in the first lateral direction.

9. The multilayer electronic component of claim 8, wherein
the second internal electrodes include via-holes through which the via-electrodes pass, and
the via-electrodes are in contact with the second internal electrodes in the via-holes.

10. The multilayer electronic component of claim 8, wherein the second group of external electrodes further includes a ninth external electrode disposed between the fifth external electrode and the seventh external electrode in the second lateral direction and between the sixth external electrode and the eighth external electrode in the first lateral direction.

11. The multilayer electronic component of claim 1, wherein the laminate further includes a dielectric layer disposed between the first and second internal electrodes, the dielectric layer surrounding at least a portion of each of the first and second internal electrodes.

12. The multilayer electronic component of claim 11, wherein the dielectric layer includes an insulating portion disposed in the recess portion of each of the first internal electrodes and surrounding the via-electrodes.

13. A multilayer electronic component comprising:
a laminate including first and second internal electrodes alternately disposed in a lamination direction, the laminate having a pair of main surfaces opposite to each other in the lamination direction, and side surfaces facing in a lateral direction, perpendicular to the lamination direction, the side surfaces connecting the pair of main surfaces to each other;
a first group of external electrodes disposed on at least one surface, among the pair of main surfaces, the first group of external electrodes adjacent to edges at which the side surfaces meet each other, the first group of external electrodes electrically connected to the first internal electrodes;
a second group of external electrodes disposed on at least one surface, among the pair of main surfaces, and between the first group of external electrodes in the lateral direction, the second group of external electrodes electrically connected to the second internal electrodes; and
via-electrodes penetrating through the laminate in the lamination direction, the via-electrodes connecting the second internal electrodes and the second group of external electrodes to each other.

14. The multilayer electronic component of claim 13, wherein the first group of external electrodes is in contact with the first internal electrodes at the side surfaces of the laminate.

15. The multilayer electronic component of claim 13, wherein
the via-electrodes are in contact with the second internal electrodes in the laminate, and
the second group of external electrodes is in contact with the via-electrodes on at least one surface, among the pair of main surfaces.

16. The multilayer electronic component of claim 13, wherein the laminate further includes a dielectric layer disposed between the first and second internal electrodes and between the first internal electrodes and the via-electrodes.

17. The multilayer electronic component of claim 13, further comprising:
additional via-electrodes penetrating through the laminate in the lamination direction, the additional via-electrodes connecting the first internal electrodes and the first group of external electrodes to each other.

18. The multilayer electronic component of claim 17, wherein
the first internal electrodes include first via-holes through which the via-electrodes pass, and first additional via-holes through which the additional via-electrodes pass,
the second internal electrodes include second via-holes through which the via-electrodes pass, and second additional via-holes through which the additional via-electrodes pass, and
the laminate further includes first insulating portions surrounding the via-electrodes in the first via-holes, and second insulating portions surrounding the additional via-electrodes in the second additional via-holes.

19. A multilayer electronic component comprising:
a laminate including first and second internal electrodes alternately disposed in a lamination direction, the laminate having a pair of main surfaces opposite to each other in the lamination direction, and side surfaces facing in a lateral direction, perpendicular to the lamination direction, the side surfaces connecting the pair of main surfaces to each other; and
a first group of external electrodes and a second group of external electrodes alternately disposed along a periphery of each of the pair of main surfaces,
wherein each of the first internal electrodes includes lead-out portions connected to the first group of external electrodes, and a body portion connecting the lead-out portions to each other, and
the second internal electrodes are connected to the second group of external electrodes, and overlap the entire body portion and a portion of each of the lead-out portions in the lamination direction.

20. The multilayer electronic component of claim 19, wherein an overlapping area between the second internal electrodes and the portion of each of the lead-out portions is about 30% or more of an overlapping area between the second internal electrodes and the entire body portion.
